(19) United States
(12) Patent Application Publication
(10) Pub. No.: US 2006/0066578 A1
(43) Pub. Date: Mar. 30, 2006

(54) Image display remote control system, image display system and method of controlling same

(75) Inventor: Mika Sugimoto, Asaka-shi (JP)

Correspondence Address: BIRCH STEWART KOLASCH & BIRCH, PO BOX 747, FALLS CHURCH, VA, 22040-0747, US

(73) Assignee: Fuji Photo Film Co., Ltd.

(21) Appl. No.: 11/231,809

(22) Filed: Sep. 22, 2005

(30) Foreign Application Priority Data
Sep. 24, 2004 (JP) 2004-276887

(51) Int. Cl. G09G 5/00

(52) U.S. Cl. 345/169

(57) ABSTRACT

Image data representing a number of images is recorded in a electronic album control apparatus. The image data is transmitted from the electronic album control apparatus to a television, and thumbnail images of a number of frames are displayed on the television screen in an array that corresponds to the array of keys on numeric keypad on a mobile telephone. If a key of the numeric keypad of the mobile telephone is pressed, data identifying the pressed key is transmitted from the mobile telephone to the electronic album control apparatus. The electronic album control apparatus determines which key has been pressed and selects an image, which corresponds to the pressed key, from among the thumbnail images being displayed on the television screen.

### BACKGROUND OF THE INVENTION

1. Field of the Invention

This invention relates to an image display remote control system, an image display system and a method of controlling the image display system.

2. Description of the Related Art

There are systems available in which the image of a subject captured using a digital still camera can be displayed on the display screen of a television by connecting the digital still camera and the television using a cable. Thumbnail images of a number of frames are displayed in the form of an array on the display screen of the television. In order to cause a desired image from among the number of thumbnail images to be displayed on the entire display screen, it is necessary to select this thumbnail image. However, a digital still camera not only has a variety of buttons such as a button with up, down, right and left arrow symbols and an ENTER button but also requires that the up, down, right, left button be pressed a number of times in order to select the desired thumbnail image.

Although there are arrangements in which a remote controller is used when images are to be displayed on a television, these do not necessarily take into account ease of operability with regard to selection of images (see the specifications of Japanese Patent Application Laid-Open Nos. 8-79671 and 2000-341614).

### SUMMARY OF THE INVENTION

Accordingly, an object of the present invention is to so arrange it that images can be selected comparatively simply.

According to a first aspect of the present invention, the foregoing object is attained by providing an image display control system comprising a remote controller and an image display system.

The remote controller includes a keypad having a plurality of keys, and an identification data transmitting device, which responds to pressing of any key among the plurality of keys of the keypad, for transmitting identification data that identifies the pressed key of the keypad to the image display system.

The image display system includes a display control device for controlling an image display device so as to display a plurality of images on a display screen in correspondence with the array of the plurality of keys of the keypad of the remote controller; an identification data receiving device for receiving the identification data that has been transmitted from the identification data transmitting device of the remote controller; and a selection identification device for identifying the fact that an image corresponding to the key of identified by the identification data that has been received by the identification data receiving device has been selected from among the plurality of images being displayed on the display screen of the image display device.

According to a second aspect of the present invention, the foregoing object is attained by providing an image display system constituting the image display control system described above. Specifically, the image display system includes a display control device for controlling an image display device so as to display a plurality of images on a display screen in correspondence with an array of a plurality of keys of a keypad of a remote controller; an identification data receiving device for receiving identification data transmitted from the remote controller and identifying a key that has been pressed among the plurality of keys of the keypad; and a selection identifying device for identifying the fact that an image corresponding to the key identified by the identification data that has been received by the identification data receiving device has been selected from among the plurality of images being displayed on the display screen of the image display device.

The second aspect of the present invention also provides a control method suited to the image display system described above. Specifically, the second aspect of the present invention provides a method of controlling an image display system, comprising the steps of: controlling an image display device so as to display a plurality of images on a display screen in correspondence with an array of a plurality of keys of a keypad of a remote controller; receiving identification data transmitted from the remote controller and identifying a key that has been pressed among the plurality of keys of the keypad; and identifying the fact that an image corresponding to the key identified by the received identification data has been selected from among the plurality of images being displayed on the display screen of the image display device.

In accordance with the second aspect of the present invention, a plurality of images corresponding to an array of a plurality of keys of a keypad of a remote controller are displayed on the display screen of an image display device. If a key of the keypad of the remote controller is pressed, identification data that identifies the pressed key of the keypad is transmitted from the remote controller to the image display system. When the identification data is received by the image display system, the fact that the image corresponding to the key of the keypad of the remote controller identified by the received identification data has been selected is identified (e.g., a border is displayed around the selected image).

Thus, a desired image can be selected merely by pressing a key of the keypad of the remote controller. This makes it possible to select an image comparatively simply.

Preferably, the image display system further includes a discriminating device for discriminating the model of the remote controller. In this case, the display control device would control the image display device so as to display a plurality of images on the display screen in correspondence with the array of keys of the keypad that conforms to the model of the remote controller discriminated by the discriminating device.

Since a plurality of images can be displayed in correspondence with the array of the keys of a keypad irrespective of the model of the remote controller, a desired image can be selected by pressing a key of the keypad.

An image display system according to a third aspect of the present invention comprises a first display control device for controlling an image display device so as to display a plurality of image groups, each of which includes a plurality of images, on a display screen in correspondence with an array of a plurality of keys of a keypad of a remote controller; an identification data receiving device for receiving identification data transmitted from the remote controller and identifying a key that has been pressed among the plurality of keys of the keypad; and a selection identifying device for identifying the fact that an image group corresponding to the key identified by the identification data that has been received by the identification data receiving device has been selected from among the plurality of image groups being displayed on the display screen of the image display device.

The third aspect of the present invention also provides a control method suited to the image display system described above. Specifically, the third aspect of the present invention provides a method of controlling an image display system, comprising the steps of: controlling an image display device so as to display a plurality of image groups, each of which includes a plurality of images, on a display screen in correspondence with an array of a plurality of keys of a keypad of a remote controller; receiving identification data transmitted from the remote controller and identifying a key that has been pressed among the plurality of keys of the keypad; and identifying the fact that an image group corresponding to the key identified by the received identification data has been selected from among the plurality of image groups being displayed on the display screen of the image display device.

In accordance with the third aspect of the present invention, a plurality of image groups each of which includes a plurality of images corresponding to an array of a plurality of keys of a keypad of a remote controller are displayed on the display screen of an image display device. If a key of the keypad of the remote controller is pressed, identification data that identifies the pressed key of the keypad is transmitted from the remote controller to the image display system. When the identification data is received by the image display system, the fact that the image group corresponding to the key of the keypad of the remote controller identified by the received identification data has been selected is identified (e.g., a border is displayed around the selected image group).

Thus, a desired image group can be selected merely by pressing a key of the keypad of the remote controller.

Preferably, the image display system further includes a second display control device for controlling the image display device so as to display the images, which are included in an image group that has been selected by the selection identifying device, on the display screen instead of the plurality of image groups.

An image display system according to a fourth aspect of the present invention comprises a keypad having a plurality of keys; an image display device for displaying a plurality of image groups, each of which includes a plurality of images, on a display screen in correspondence with the array of the plurality of keys of the keypad; a determination device for finding which key of the plurality of keys of the keypad has been pressed; and a display control device for controlling the image display device in such a manner that the images included in the image group corresponding to the key of found by the determination device are displayed on the display screen.

The fourth aspect of the present invention also provides a control method suited to the image display system described above. Specifically, the fourth aspect of the present invention provides a method of controlling an image display system, comprising the steps of: providing an image display system with a keypad having a plurality of keys, and an image display device for displaying a plurality of image groups, each of which includes a plurality of images, on a display screen in correspondence with the array of the plurality of keys of the keypad; finding which key of the plurality of keys of the keypad has been pressed; and identifying the fact that the image group corresponding to the key found has been selected.

In accordance with the fourth aspect of the present invention, an image display system is provided with a keypad having a plurality of keys. Image groups, each of which includes a plurality of images, are displayed on a display screen in correspondence with the array of the plurality of keys of the keypad. If any key among the plurality of keys of the keypad is pressed, the pressed key is found and the image group corresponding to the found key is selected. Thus, a desired image group can be selected by pressing a key of the keypad.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 illustrates an image display control system;

FIG. 2 illustrates the external appearance of a mobile telephone;

FIG. 3 is a block diagram illustrating the electrical structure of the mobile telephone;

FIG. 4 is a block diagram illustrating the electrical structure of an electronic album control apparatus;

FIG. 5 is a correspondence table illustrating the relationship between mobile telephone models and keypad arrays;

FIGS. 6 and 7 are flowcharts illustrating processing executed by the electronic album control apparatus;

FIGS. 8 to 11 illustrate examples of images displayed on a television;

FIG. 12 illustrates the external appearance of a store printing apparatus;

FIG. 13 is a block diagram illustrating the electrical structure of the store printing apparatus; and

FIG. 14 is a flowchart illustrating processing executed by the store printing apparatus.

### DESCRIPTION OF THE PREFERRED EMBODIMENTS

A preferred embodiment of the present invention will now be described in detail with reference to the drawings.

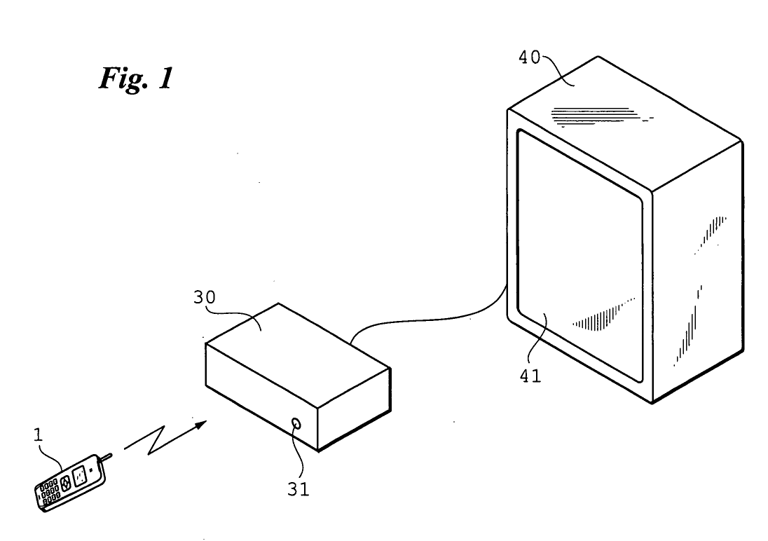

FIG. 1 illustrates an image display control system according to an embodiment of the present invention.

The image display control system includes a mobile telephone (remote controller) 1, an electronic album control apparatus (image display system) 30 and a television 40.

The mobile telephone 1 and electronic album control apparatus 30 are capable of infrared communication. To accomplish this, the electronic album control apparatus 30 is provided with an infrared communication unit 31. The electronic album control apparatus 30 and television 40 are connected by a cable so that image data can be transmitted from the electronic album control apparatus 30 to the television 40.

In the image display control system according to this embodiment, a number of thumbnail images represented by image data that has been stored in the electronic album control apparatus 30 are displayed on a display screen 41 of the television 40, and a desired thumbnail image can be selected from among the displayed thumbnail images using the mobile telephone 1. More specifically, thumbnail images corresponding to the array of keys of the keypad on the mobile telephone 1 are displayed on the display screen 41 of the television 40. Since the array of thumbnail images and the array of keys of the keypad on the mobile telephone 1 correspond, thumbnail images can be selected intuitively using the mobile telephone 1.

Although the mobile telephone 1 is utilized in this embodiment, it is possible to use any device, and not just a mobile telephone, that is provided with a numeric keypad and is capable of sending the electronic album control apparatus 30 a signal indicating which key of the keypad has been pressed, as in the manner of a remote control device for a television.

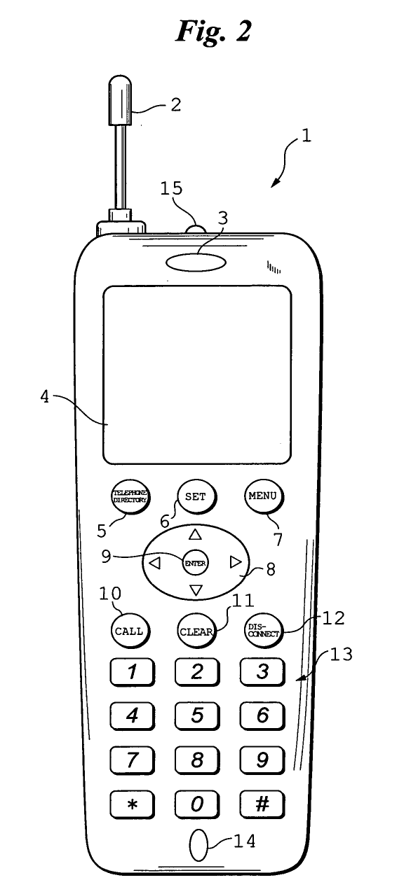

FIG. 2 illustrates the external appearance of the mobile telephone 1.

An antenna 2 is provided on the left side of the mobile telephone 1 on its upper end. Further, an infrared communication unit 15 for infrared communication with the electronic album control apparatus 30 as described above is provided on the top end of the mobile telephone 1 approximately at the center thereof.

A speaker 3 is provided on the front side of the mobile telephone 1 at the upper portion thereof. A display screen 4 is formed below the speaker 3.

Provided underneath the display screen 4 are a telephone directory button 5 pressed when a telephone directory is to be displayed, a setting button 6, a menu button 7 pressed when various menus are to be displayed, a button 8 with up, down, left, right arrow symbols, an ENTER button 9, a call button 10 pressed when a connection is to be made to the telephone of another party, a CLEAR button 11, a disconnect button 12 pressed to disconnect the telephone, and a numeric keypad 13.

A microphone 14 is provided on the front side of the mobile telephone 1 at the lower portion thereof.

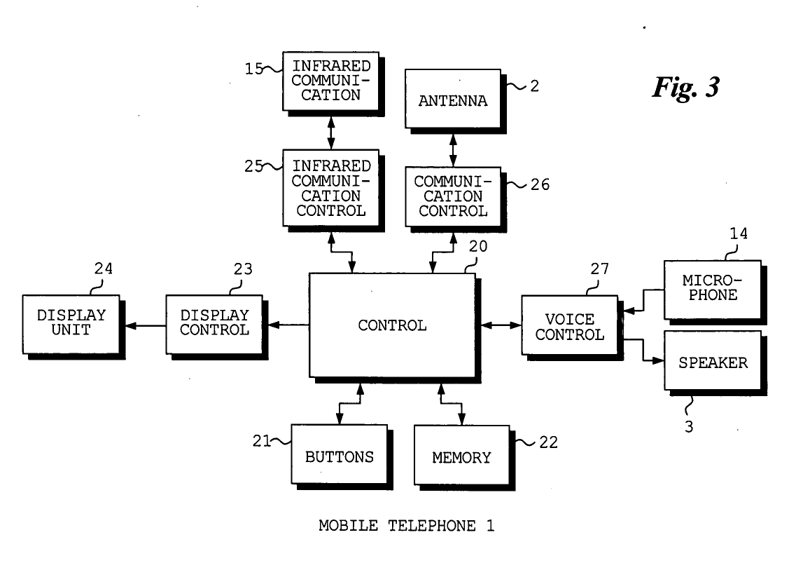

FIG. 3 is a block diagram illustrating the electrical structure of the mobile telephone 1.

The operation of the overall mobile telephone 1 is controlled by a control unit 20.

The mobile telephone 1 is provided with the various buttons 5 to 12 and numeric keypad 13, as mentioned above. The buttons and numeric keypad 13 are indicated by a button block 21 in FIG. 3. Signals from the button block 21 are input to the control unit 20. Connected to the control unit 20 is a memory 22 for storing various data temporarily.

The mobile telephone 1 is further provided with the microphone 14 and speaker 3, as mentioned above. Voice applied to the microphone 14 is converted to a voice signal. By applying the voice signal to the antenna 2 via a voice control circuit 27, the control unit 20 and a communication control circuit 26, the signal is transmitted as voice data to the mobile telephone of the communicating party. Voice data that has been transmitted from the mobile telephone 1 of the communicating party is received by the antenna 2 and applied to the speaker 3 via the communication control circuit 26, control unit 20 and voice control circuit 27. The voice of the communicating party is output from the speaker 3.

As mentioned above, the mobile telephone 1 is provided with the infrared communication unit 15, which is controlled by an infrared communication control circuit 25. The mobile telephone 1 includes a display unit 24 having the above-mentioned display screen 4. The display unit 24 is controlled by a display controller 23.

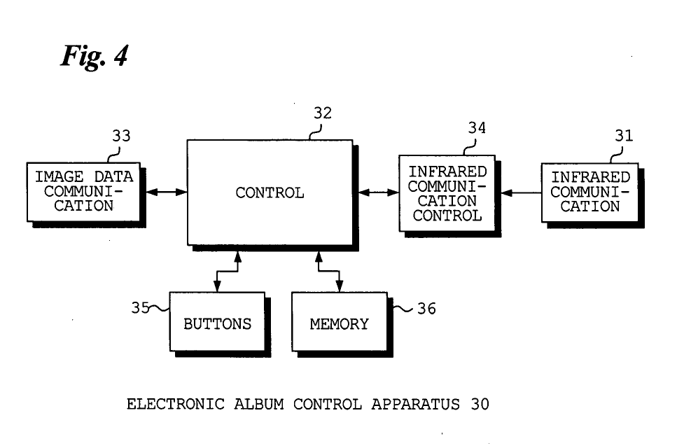

FIG. 4 is a block diagram illustrating the electrical structure of the electronic album control apparatus 30.

The operation of the overall electronic album control apparatus 30 is controlled by a control unit 32.

The electronic album control apparatus 30 is provided with an operation button 35. The latter outputs an operation signal that is input to the control unit 32. Connected to the control unit 32 is a memory (which may of course be a hard disk or the like) 36 storing image data representing a number of images and an thumbnail image data representing thumbnail images.

The electronic album control apparatus 30 includes an infrared communication unit 31 and an infrared communication controller 34. The electronic album control apparatus 30 further includes an image data communication unit 33 for transmitting image data to the television 40.

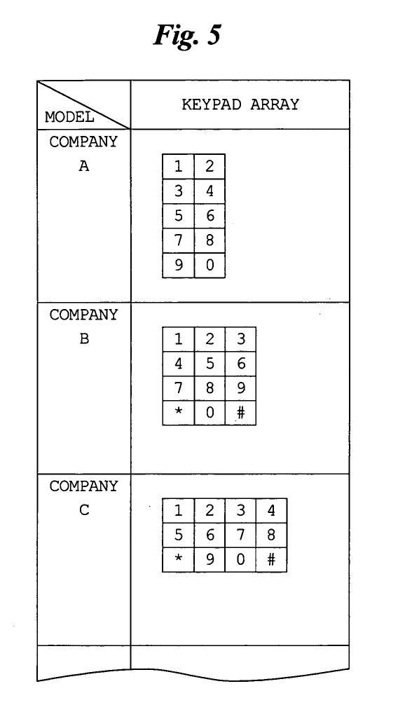

FIG. 5 is a correspondence table showing correspondence between models of mobile telephones and numeric keypad arrays of these models.

The image display control system according to this embodiment is such that images (image groups) are displayed on the display screen 41 of the television 40 in correspondence with the array of the keys of the numeric keypad on a mobile telephone. However, the key array of the numeric keypad of a mobile telephone differs depending upon the model of the mobile telephone. For this reason, numeric keypad arrays corresponding to the models of the mobile telephones have been stored in the electronic album control apparatus 30. The latter discriminates the model of the mobile telephone to ascertain the key array of its numeric keypad. Thumbnail images are displayed on the display screen 41 of the television 40 in correspondence with the array of the keys of the numeric keypad that conforms to the model of the mobile telephone.

For example, if the mobile telephone is that of Company A, the key array of the numeric keypad of this mobile telephone is an array composed of four rows and two columns. If the mobile telephone is that of Company B, the key array of the numeric keypad of this mobile telephone is an array composed of four rows and three columns (see also FIG. 2). If the mobile telephone is that of Company C, the key array of the numeric keypad of this mobile telephone is an array composed of three rows and four columns.

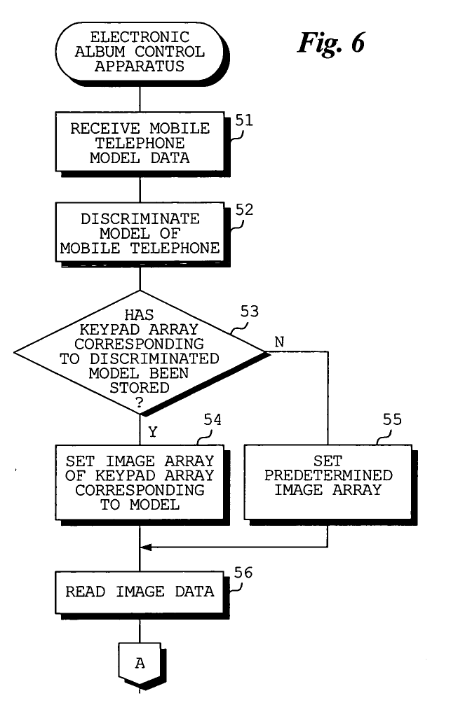

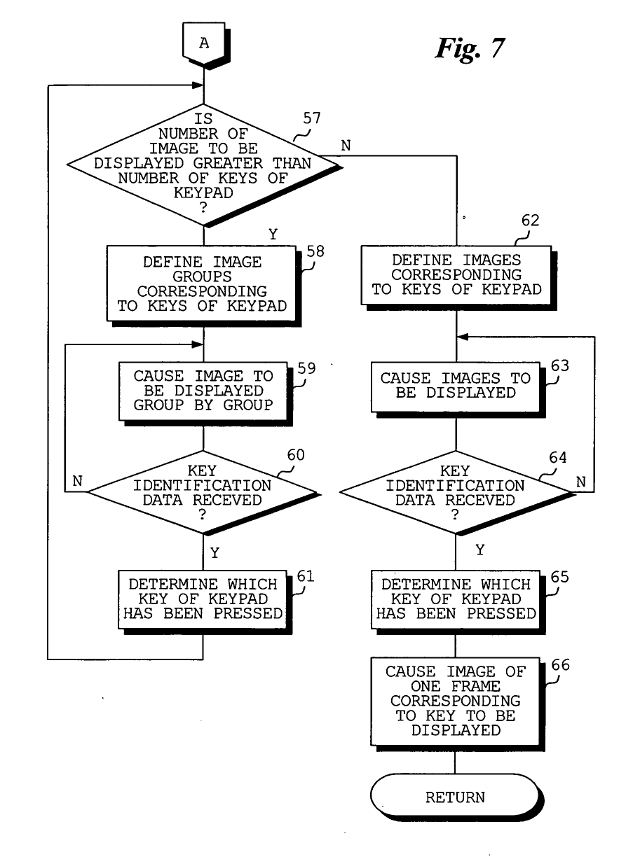

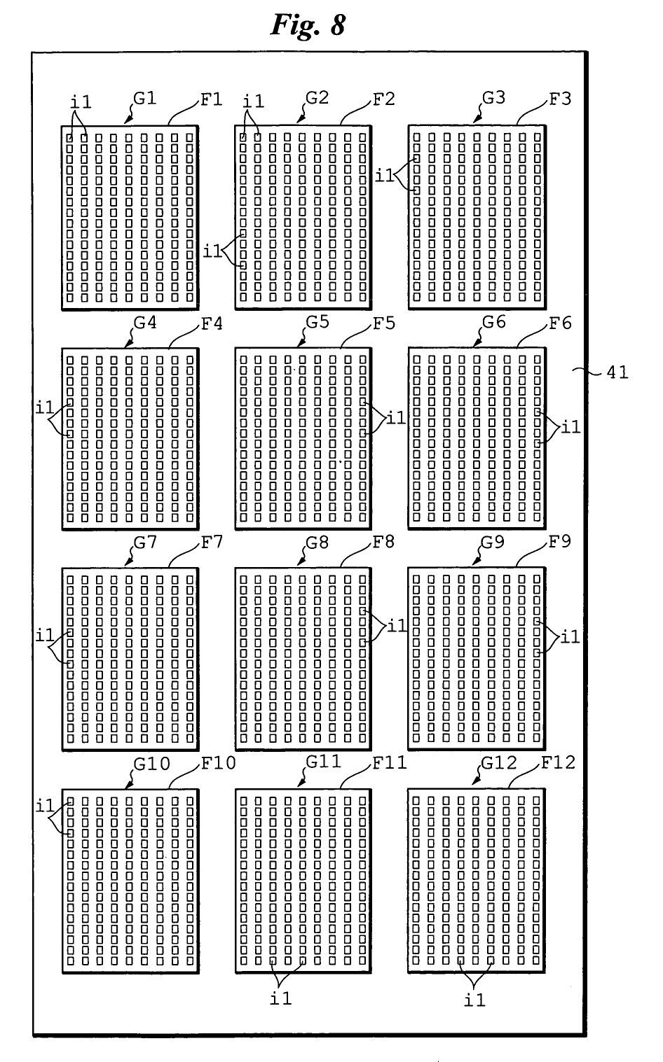

FIGS. 6 and 7 are flowcharts illustrating processing executed by the electronic album control apparatus 30, and FIGS. 8 to 10 illustrate examples of images, displayed on the display screen 41 of the television 40.

In the example illustrated below, it will be assumed that use is made of the mobile telephone 1 having the numeric keypad 13 composed of keys in four rows and three columns, as illustrated in FIG. 2.

A menu is displayed using the menu button 7 on the mobile telephone 1, and electronic album control is selected from the menu using the up, down, left, right button 8 and setting button 6. If the ENTER button 9 is pressed, then model data indicating the model of mobile telephone 1 is transmitted from the mobile telephone 1 to the electronic album control apparatus 30.

Upon receiving the model data transmitted from the mobile telephone 1 (step 51), the electronic album control apparatus 30 discriminates the model of the mobile telephone 1 based upon the model data (step 52).

If the array of the keys of the keypad corresponding to the discriminated model is contained in the correspondence table and has been stored in the memory 36 (“YES” at step 53), an image array of the keypad array corresponding to the model is set in the electronic album control apparatus 30 (step 54). If the key array of the keypad corresponding to the discriminated model has not been stored in the memory 36 (or if the model of the mobile telephone 1 itself cannot be discriminated) (“NO” at step 53), then a predetermined image array is set in the electronic album control apparatus 30 (step 55).

When the image array is set, image data that has been stored in the memory 36 is read (step 56). Next, the apparatus checks to determine whether the number of images to be displayed on the display screen 41 of the television 40 is greater than the number of keys of the numeric keypad of the mobile telephone 1 that has been discriminated (or greater than a number decided by an image array that has been set in advance) (step 57).

If the number of images to be displayed is greater than the number of keys of the numeric keypad (“YES” at step), then the images to be displayed and the keys of the numeric keypad will not be in one-to-one correspondence. In this embodiment, therefore, thumbnail images the number of which is greater than the number of keys of the numeric keypad are displayed on the display screen 41 of the television 40 upon grouping them so as to correspond to the number of keys of the numeric keypad. In order present such a display, image groups corresponding to the keys of the numeric keypad are defined (step 58). When this is done, the grouped images are displayed on the display screen 41 of the television 40 in correspondence with the keys of the numeric keypad of the mobile telephone 1 (step 59).

When image data representing a number of images is transmitted from the electronic album control apparatus 30 to the television 40, a number of thumbnail images (27 thumbnail images horizontally and 64 thumbnail images vertically in this example) i1 are displayed on the display screen 41 of the television 40, as illustrated in FIG. 8. The number of thumbnail images i1 are divided up into image groups G1 to G12 in four rows and three columns corresponding to the numeric keypad of the mobile telephone 1. Borders F1 to F12 also are displayed enclosing respective ones of the groups G1 to G12 in order that the user may recognize the individual groups.

The groups G1, G2, G3, G4, G5, G6, G7, G8, G9, G10, G11 and G12 correspond to the keys “1”, “2”, “3”, “4”, “5”, “6”, “7”, “8”, “9”, “*”, “0” and “#”, respectively, on the numeric keypad 13 of mobile telephone 1. If any key among the keys of numeric keypad 13 is pressed, the group corresponding to the pressed key is selected. If any key is pressed, data that identifies the key is transmitted from the mobile telephone 1 to the electronic album control apparatus 30.

When the key identification data transmitted from the mobile telephone 1 is received by the electronic album control apparatus 30 (“YES” at step 60 in FIG. 7), which key of the keypad has been pressed is determined based upon this key identification data (step 61). Assume that the “1” key has been pressed. When this is done, the fact that group G1 corresponding to the pressed key has been selected is identified and it is again determined whether the number of images (to be displayed) contained in group G1 is greater than the number of keys of the numeric keypad 13 (step 57). Here the number of images in group G1 is nine horizontally and 16 vertically and therefore the total number of images is greater than the number of keys on numeric keypad 13. Consequently, grouping is defined again in correspondence with the key array of numeric keypad 13 with regard to the images in group G1, and the images are displayed group by group (steps 58, 59).

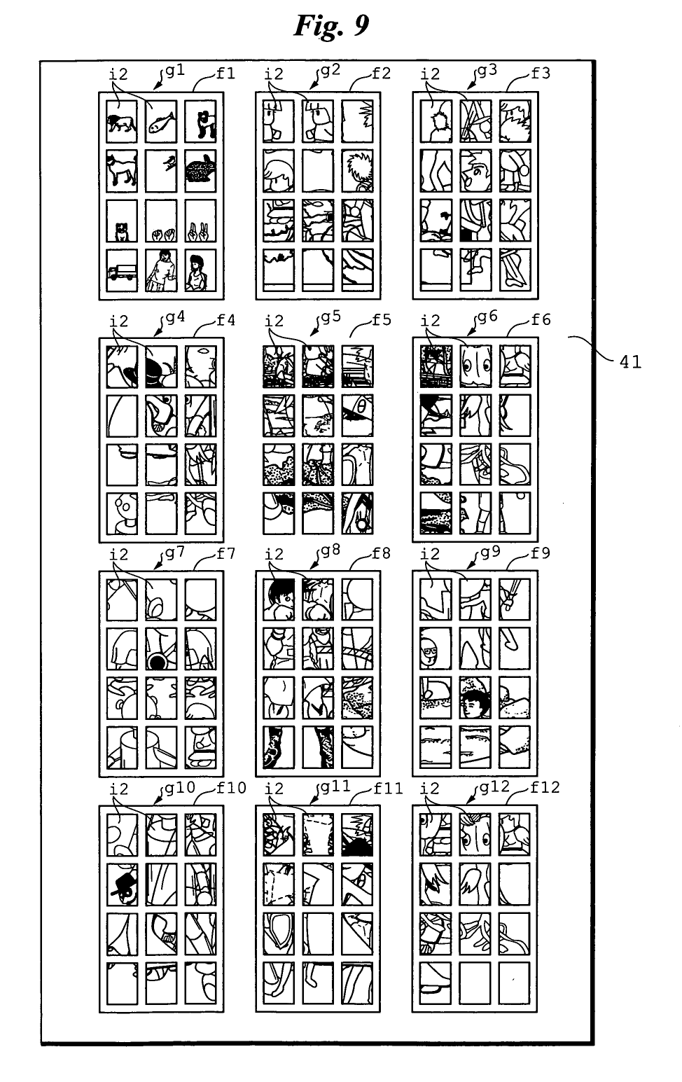

The thumbnail images i1 in group G1 are displayed upon being grouped into image groups g1 to g12 of four rows and three columns in correspondence with the array of numeric keypad 13, as shown in FIG. 9. Borders f1 to f12 also are displayed enclosing respective ones of the groups g1 to g12 in order that the user may ascertain these groups. Each of the groups g1 to g12 includes thumbnail images i2 that are larger than the thumbnail images i1. By pressing a key on the numeric keypad 13 of mobile telephone 1, the group corresponding to the pressed key is selected in a manner similar to that described above. If the “2” key on the numeric keypad 13 is pressed, then group g2 will be selected. The number of images in group g2 is counted.

Since the number of images in group g2 is the same as the number of keys (although the number of images may just as well be less than the number of keys) (“NO” at step 57), the images and the keys of the keypad are in one-to-one correspondence. Accordingly, the images in one-to-one correspondence with the keys of the keypad are defined (step 62) and the images are displayed in correspondence with the keys of the numeric keypad 13 (step 63).

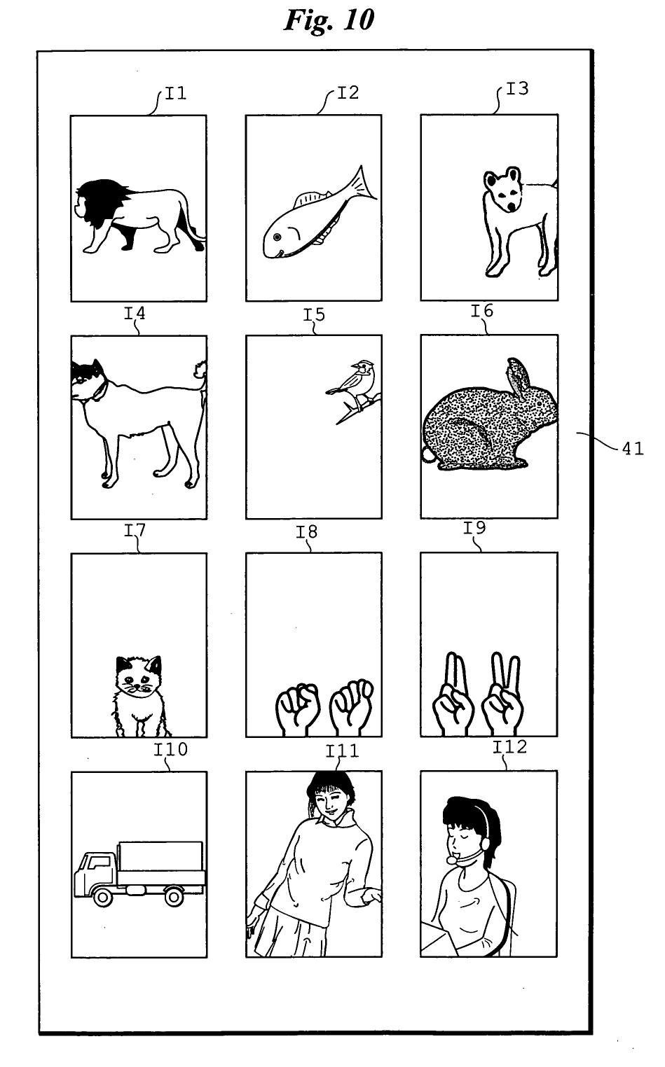

As shown in FIG. 10, thumbnail images 11 to 112 in one-to-one correspondence with respective ones of the keys of numeric keypad 13 are displayed on the display screen 41 of television 40. The thumbnail image I1, I2, I3, I4, I5, I6, I7, I8, I9, I10, I11 and I12 correspond to the keys “1”, “2”, “3”, “4”, “5”, “6”, “7”, “8”, “9”, “*”, “0” and “#”, respectively, on the numeric keypad 13. Pressing any one of these keys selects the corresponding thumbnail image.

With reference again to FIG. 7, when the key identification data transmitted from the mobile telephone 1 is received by the electronic album control apparatus 30 (“YES” at step 64), the latter determines, based upon the key identification information, which key has been pressed (step 65). When this is determined, image data representing the image corresponding to the thumbnail image that corresponds to the determined key is read out of the memory 36 and transmitted to the television 40. The image of the single selected frame is identified and displayed on the entirety of the display screen 41 of television 40 (step 66).

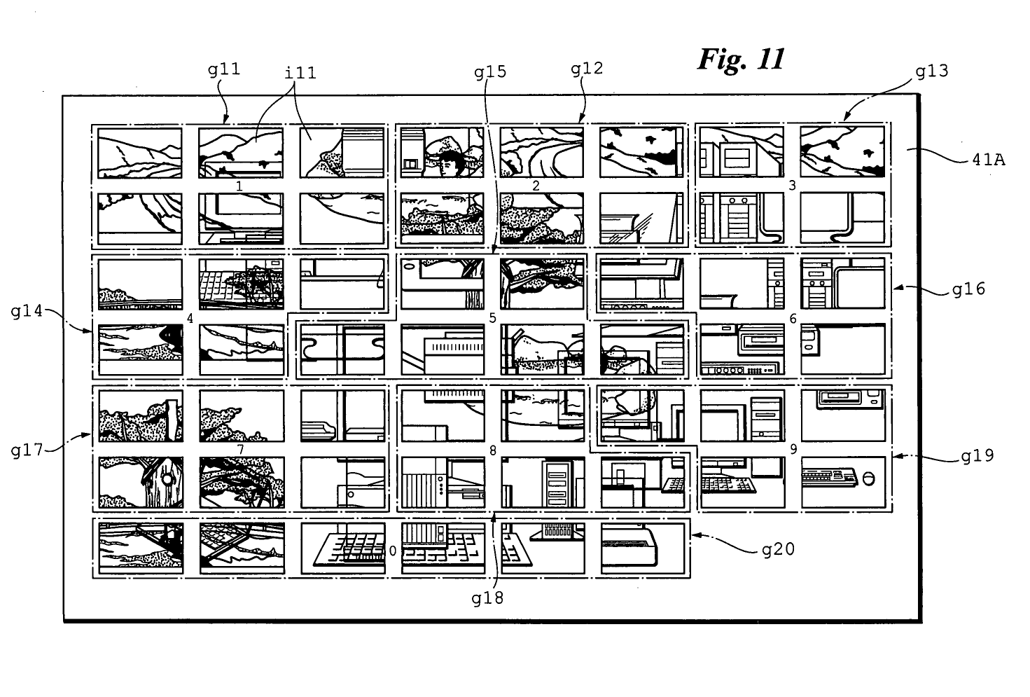

FIG. 11 illustrates an example of thumbnail images displayed on a display screen 41A of a television.

Image groups g11 to g20 are not all enclosed by borders of the same shape. Here the borders are of different shapes. Further, the number of thumbnail images i contained in each group differs from group to group.

In the above-described embodiment, although the number of images contained in each group is same, may differ from group to group. Further the shape of the group (the border) may differ from group to group.

Further, in the above-described embodiment, image data is read from the memory 36 after the model of the mobile telephone 1 is discriminated. However, it may be so arranged that image data is read first and then the model of the mobile telephone 1 discriminated.

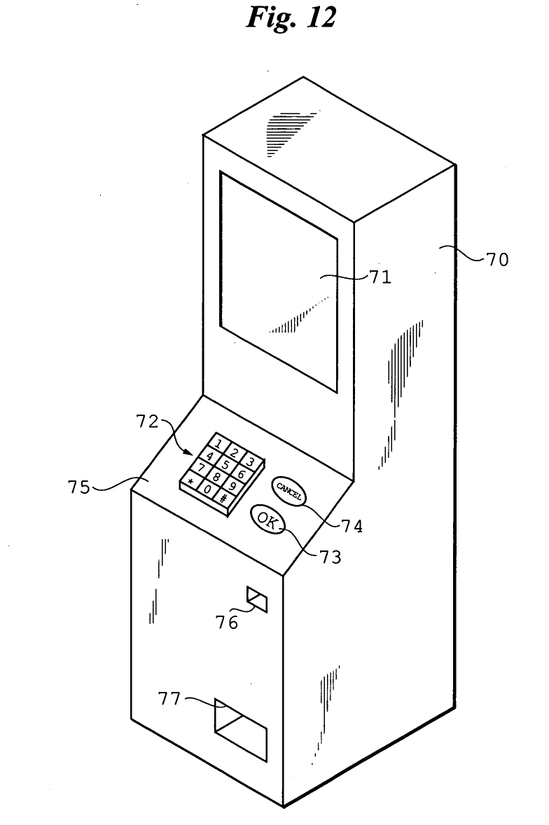

FIGS. 12 to 14 illustrate another embodiment of the present invention and relate to a printing apparatus located in a store.

FIG. 12 illustrates the external appearance of a store printing apparatus 70.

The store printing apparatus 70 prints images represented by image data that has been recorded on a memory card brought to the store by a user.

A display screen 71 is provided on the upper portion of the store printing apparatus 70 on the front side thereof. An operating console 75 protruding from the front side of the store printing apparatus 70 is formed on the front side of the store printing apparatus 70 approximately at the center thereof. The operating console 75 is provided with a numeric keypad 72 having an array of keys identical with that of the numeric keypad (see FIG. 2) of mobile telephone 1 described above. That is, the numeric keypad 72 includes keys “1” to “9”, “0”, “*” and “#” in four rows and three columns. A cancel key 74 and an OK button 73 are provided on the right side of the keypad.

The lower portion of the store printing apparatus 70 on the front side thereof is formed to have a memory card insertion port 76 for inserting a memory card brought by the user. A print ejection port 77 is formed below the memory card insertion port 76.

In the store printing apparatus 70, in a manner similar to that described above, images (thumbnail images) represented by image data that has been recorded on a memory card are displayed in image groups, as shown in FIG. 8 or 9, in correspondence with the array of the keys constructing the numeric keypad 72. By pressing a desired key among the keys of the numeric keypad 72, the corresponding image group among a number of image groups is selected.

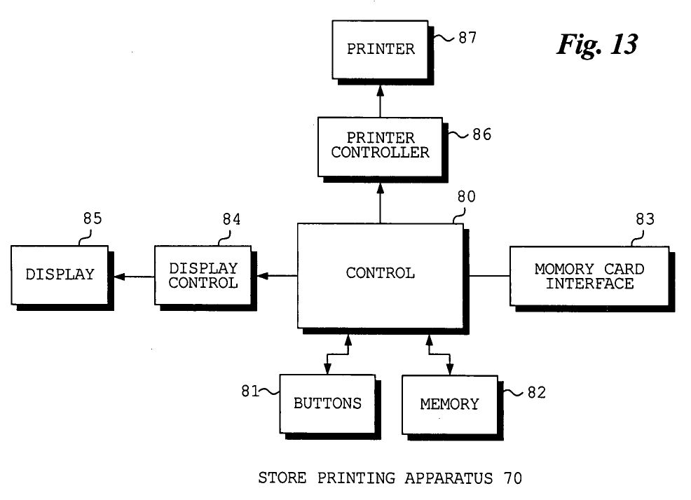

FIG. 13 is a block diagram illustrating the electrical structure of the store printing apparatus 70.

The operation of the overall store printing apparatus 70 is controlled by a control unit 80. Output signals from buttons 81 that include the above-mentioned numeric keypad 72 and buttons 73 and 74 are input to the control unit 80. Further, a memory 82 for storing data and the like temporarily is connected to the control unit 80.

The store printing apparatus 70 includes a memory card interface 83 for reading image data that has been recorded on an inserted memory card. The store printing apparatus 70 further includes a display unit 85 having the display screen 71 and a display controller 84 for controlling the display unit 85 in a manner similar to that described above. The store printing apparatus 70 further includes a printer 87 for printing images and a printer controller 86 for controlling the printer 87.

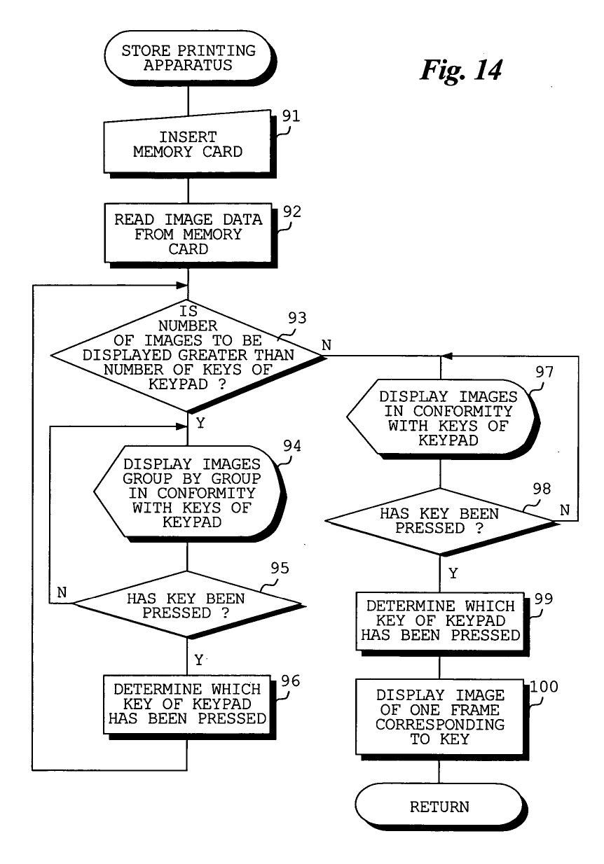

FIG. 14 is a flowchart illustrating processing executed by the store printing apparatus 70.

A memory card brought by the user is inserted into the apparatus from the memory card insertion port 76 (step 91). When this is done, the image data that has been recorded on the inserted memory card is read into the store printing apparatus 70 (step 92). It is determined whether the number of images represented by the read image data is greater than the number of keys constituting the numeric keypad 72 (step 93).

If the number of images is greater (“YES” at step 93), the images are divided into groups in correspondence with the array of the keys of the numeric keypad 72 and the images are displayed group-by-group (step 94). If a key of the keypad is pressed, which key has been pressed is discriminated (step 96). A check is performed to determine whether the number of images in the group corresponding to the pressed key is still greater than the number of keys of the keypad (step 93). If the number of images is greater, the processing from steps 94 to 96 is repeated. If the number images is not greater, then the images are displayed on the display screen 71 one frame at a time in one-to-one correspondence with the array of keys of numeric keypad 72 (step 97) (see also FIG. 10).

If any key of the numeric keypad 72 is pressed (“YES” at step 98), which key has been pressed is determined (step 99). The image of the frame corresponding to the pressed key is displayed on the entirety of the display screen 71 (step 100).

Thus, the numeric keypad that designates images and the device that controls the display of the image need not necessarily be separate.

In the above-described embodiment, thumbnail images displayed on the display screen 41 (or 71) are in groups spaced apart from one another in such a manner that the thumbnail images in one group can be distinguished from the thumbnail images in another group. However, the groups need not necessarily be spaced apart. Further, it will suffice if images (image groups) are displayed in correspondence with the key array of a mobile telephone, and each group need not be provided with a border.

As many apparently widely different embodiments of the present invention can be made without departing from the spirit and scope thereof, it is to be understood that the invention is not limited to the specific embodiments thereof except as defined in the appended claims.

What is claimed is:

1. An image display control system comprising a remote controller and an image display system, wherein said remote controller includes:
a keypad having a plurality of keys; and
an identification data transmitting device, which responds to pressing of any key among the plurality of keys of said keypad, for transmitting identification data that identifies the pressed key of said keypad to said image display system; and
said image display system includes:
a display control device for controlling an image display device so as to display a plurality of images on a display screen in correspondence with the array of the plurality of keys of said keypad of said remote controller;
an identification data receiving device for receiving the identification data that has been transmitted from said identification data transmitting device of said remote controller; and
a selection identification device for identifying the fact that an image corresponding to the key identified by the identification data that has been received by said identification data receiving device has been selected from among the plurality of images being displayed on the display screen of the image display device.

2. An image display system comprising:
a display control device for controlling an image display device so as to display a plurality of images on a display screen in correspondence with an array of a plurality of keys of a keypad of a remote controller;
an identification data receiving device for receiving identification data transmitted from the remote controller and identifying a key that has been pressed among the plurality of keys of the keypad; and
a selection identifying device for identifying the fact that an image corresponding to the key identified by the identification data that has been received by said identification data receiving device has been selected from among the plurality of images being displayed on the display screen of the image display device.

3. The system according to claim 2, further comprising a discriminating device for discriminating the model of the remote controller;
wherein said display control device controls the image display device so as to display a plurality of images on the display screen in correspondence with the array of keys of the keypad that conforms to the model of the remote controller discriminated by said discriminating device.

4. An image display system comprising:
a first display control device for controlling an image display device so as to display a plurality of image groups, each of which includes a plurality of images, on a display screen in correspondence with an array of a plurality of keys of a keypad of a remote controller;
an identification data receiving device for receiving identification data transmitted from the remote controller and identifying a key that has been pressed among the plurality of keys of the keypad; and
a selection identifying device for identifying the fact that an image group corresponding to the key identified by the identification data that has been received by said identification data receiving device has been selected from among the plurality of image groups being displayed on the display screen of the image display device.

5. The system according to claim 4, further comprising a second display control device for controlling the image display device in such a manner that instead of the plurality of image groups being displayed, images included in an image group that has been selected by said selection identifying device are displayed on the display screen.

6. An image display system comprising:
a keypad having a plurality of keys;
an image display device for displaying a plurality of image groups, each of which includes a plurality of images, on a display screen in correspondence with the array of the plurality of keys of the keypad;
a determination device for finding which key of the plurality of keys of the keypad has been pressed; and
a display control device for controlling said image display device in such a manner that the images included in the image group corresponding to the key found by said determination device are displayed on the display screen.

7. A method of controlling an image display system, comprising the steps of:
controlling an image display device so as to display a plurality of images on a display screen in correspondence with an array of a plurality of keys of a keypad of a remote controller;
receiving identification data transmitted from the remote controller and identifying a key that has been pressed among the plurality of keys of the keypad; and
identifying the fact that an image corresponding to the key identified by the received identification data has been selected from among the plurality of images being displayed on the display screen of the image display device.

8. A method of controlling an image display system, comprising the steps of:
controlling an image display device so as to display a plurality of image groups, each of which includes a plurality of images, on a display screen in correspondence with an array of a plurality of keys of a keypad of a remote controller;
receiving identification data transmitted from the remote controller and identifying a key that has been pressed among the plurality of keys of the keypad; and
identifying the fact that an image group corresponding to the key identified by the received identification data has been selected from among the plurality of image groups being displayed on the display screen of the image display device.

9. A method of controlling an image display system, comprising the steps of:
providing an image display system with a keypad having a plurality of keys, and an image display device for displaying a plurality of image groups, each of which includes a plurality of images, on a display screen in correspondence with the array of the plurality of keys of the keypad;
finding which key of the plurality of keys of the keypad has been pressed; and
identifying the fact that the image group corresponding to the key found has been selected.
